(19) United States
(12) Patent Application Publication
(10) Pub. No.: US 2015/0006299 A1
(43) Pub. Date: Jan. 1, 2015

(54) METHODS AND SYSTEMS FOR DYNAMIC CUSTOMIZATION OF ADVERTISEMENTS

(71) Applicant: VONAGE NETWORK LLC, Holmdel, NJ (US)

(72) Inventors: Tzahi EFRATI, Hoboken, NJ (US); James A. SMITH, Matawan, NJ (US)

(21) Appl. No.: 13/930,085

(22) Filed: Jun. 28, 2013

(51) Int. Cl. G06Q 30/02

(52) U.S. Cl. CPC G06Q 30/0269
USPC 705/14.67

(57) ABSTRACT

A system and method for dynamically customizing advertisements is disclosed. In some embodiments the system and method includes identifying components of an advertisement for customization, identifying user preferences relevant to the advertisement component and modifying the advertisement component based on the user preference to create a customized advertisement.

### BACKGROUND OF THE INVENTION

1. Field of the invention

The present invention generally relates to methods and systems for creating customized advertisements targeted to a particular customer.

2. Description of the Related Art

People are naturally attracted to objects that have a personally familiar aspect to them. For example, a person who collects dolls may be attracted to a photograph that contains dolls. In another example, a person who enjoys sunsets may be attracted to a picture that includes a sunset in the background. In yet another example, a person that finds certain types of voices especially attractive or soothing may be attracted to a message delivered in a voice possessing those types of voices. This can be particularly helpful in an advertisement. If there is an aspect in the advertisement that is familiar to a customer that the advertiser is trying to attract, they may be more inclined to view or listen to the advertisement and to react positively to the advertisement. The familiarity may include the recognition of a face, a voice, an expression or an image, for example.

Currently, targeted advertisement methods exist that can be tailored to a specific user based on the user's characteristics or prior activity. For example, a user that has been searching for car sales may be shown car advertisements in a website that the user commonly views for current weather conditions. This type of targeted advertising, however, is limited to presenting the user with a pre-made advertisement of a product or service that coincides with the user's tracking and history data. However, the actual contents of these targeted advertisements are not customized to a specific user.

Accordingly, there exists a need for methods and systems that dynamically customize advertisements specifically targeted to consumers, by tailoring advertisements to contain aspects that are personally familiar to the consumer and/or for which the consumer may otherwise have a preference.

### SUMMARY OF THE INVENTION

A system and method for dynamically customizing advertisements is disclosed. In some embodiments the system and method includes identifying components of an advertisement for customization, identifying user preferences relevant to the advertisement component and modifying the advertisement component based on the user preference to create a customized advertisement.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram of a communication network environment in accordance with one or more of the embodiments of the invention;

FIG. 2 is a diagram of elements of an advertisement processing system in accordance with one or more of the embodiments of the invention;

FIG. 3a is a diagram of an exemplary screen view of identified components of an advertisement in accordance with one or more embodiments of the invention;

FIG. 3b is a diagram of an exemplary screen view of the modified components of an advertisement in accordance with one or more embodiments of the invention; and

FIG. 4 is a flow diagram of an exemplary method of dynamically modifying an advertisement in accordance with one or more embodiments of the invention.

FIG. 4a is a flow diagram of an exemplary method for identifying components of an advertisement for modification.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

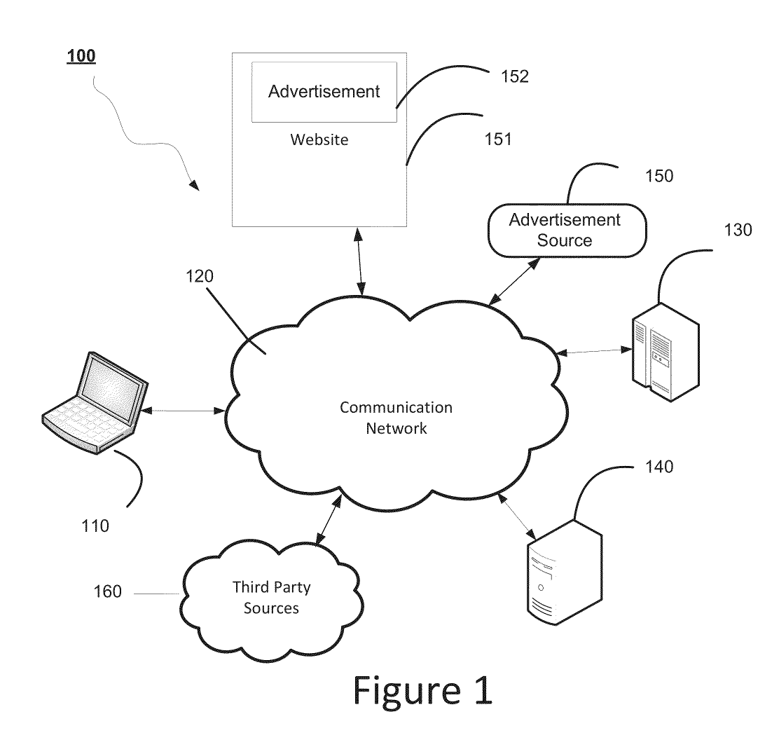

FIG. 1 is a diagram of a communication network environment 100 including an access device 110 to connect to a communication network 120 and an advertisement processing system 130 that is also connected to communication network 120. Communication network 120 further includes user database 140 and at least one advertisement source 150. Website 151 may be accessed by access device 110 through communication network 120. The communication network 120 may be one or more networks such as Internet Protocol (IP) networks or public switched telephone networks (PSTN) used to connect the access device 110 and advertisement processing system 130.

Moreover, communication network 120 may be in communication with social media sites, blogs or other third party sources 160 where users may participate in an audio or video communication, share still images, or correspond in written exchanges.

User database 140 may contain data collected by communication network 120 for each user of communication network 120. Communication network 120 may require users to register in order to access the network. This registration may take the form of a password protected login, a user phone number or other methods capable of registering a user for access to the communication network 120. Communication network 120 could then compile data for a user profile which can be accessed by advertisement processing system 130 in order to customize the advertisements 152 specifically for the requesting user. The data collected may include demographic information, user preferences, voice recordings, photo images, written communications and the like.

User database 140 may be part of communication network 120 or separate from communication network 120 in a remote location but in communication with communication network 120.

The advertisement processing system 130 may be part of communication network 120 or separate from communication network 120 but in communication with communication network 120.

The advertisement processing system 130 is also able to obtain user data from social networks, blogs or other third party sources 160. For example, a user may have a Facebook® account, and a variety of items of information for the user may be present within Facebook®. This information could include user profiles, photos, recorded communications, written communications, etc.

In some instances, the user may have provided the communication network 120 with permission to obtain information from the user's account with the third party source 160 as in a social network for example. The user may have also provided the communication network 120 with the user's credentials on the social network, in the form of a user name and password, so that the communication network 120 can log into the social network to review and retrieve information from the contact's account on the social network. In some instances, the communication network 120 may have received authorization from a user to access certain information on a social networking system, and the communication network 120 may be able to access this information without actually logging into the social networking system with the user's name and password. The advertisement processing system 130 can subsequently obtain user data from a social network through communication network 120.

Blogs and other third party sources 160 may provide access to user's accounts as in the example of a social network above.

Website 151 is accessed by access device 110 through communication network 120. Website 151 is further in communication with advertisement source 150 which provides data for advertisement 152. When a user on access device 110 accesses the website 151, website 151 notifies advertisement processing unit 130 through an Application Programming Interface (API) call that advertisement 152 is being accessed from website 151 and is available for modification through embodiments of the present invention that will be described below. The advertisement 152 may also be accessible independently; contained in a launched application; or may be shown as part of any other online source that includes an advertisement.

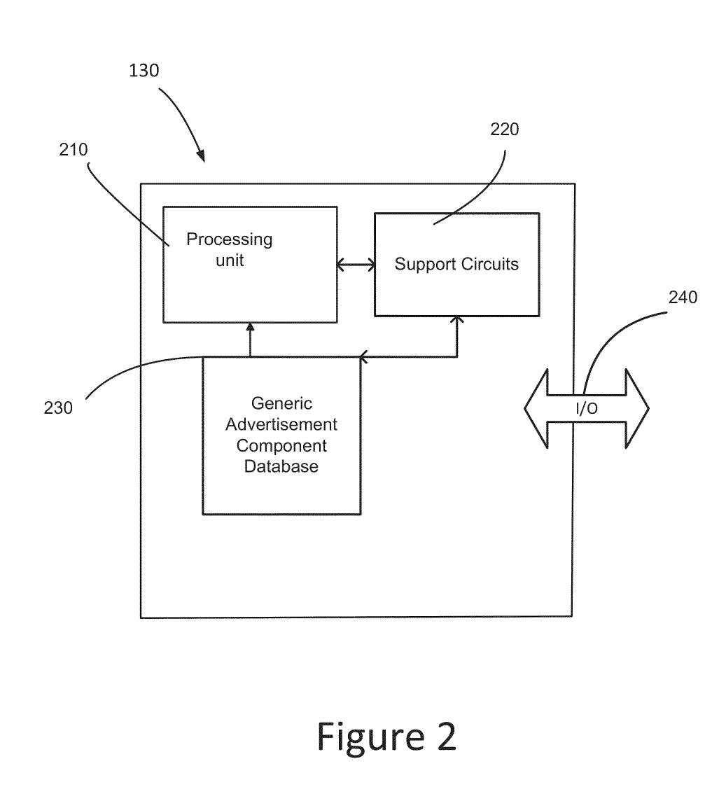

FIG. 2 depicts a diagram of elements of an advertisement processing system 130 embodying the invention. The system 130 includes a processing unit 210, support circuits 220, generic advertisement component database 230 and input/output interface 240. The support circuits 220 include circuits for interfacing with the processing unit 210 and input/output interface 240. I/O interface 240 may provide advertisement processing system 130 with the ability to interface with communication network 120.

Generic advertisement component database 230 may contain a variety of sample images, voice data, print data, background setting or the like. The image data may include human models, animals, buildings, scenery or the like. Voice data may include words, phrases, quotes or the like. The print data may include words, phrases, quotes or the like. The background may include natural environments, indoor settings, colors, patterns or the like. As will be discussed further below, the components available in generic advertisement component database 230 will be used to replace existing components in advertisement source 150 to modify advertisement 152 as displayed to a user. Components of advertisement source 150 will be identified as components appropriate for modification and the components in advertisement component database 230 will be used to replace those identified components to create a modified advertisement in accordance with embodiments of the invention.

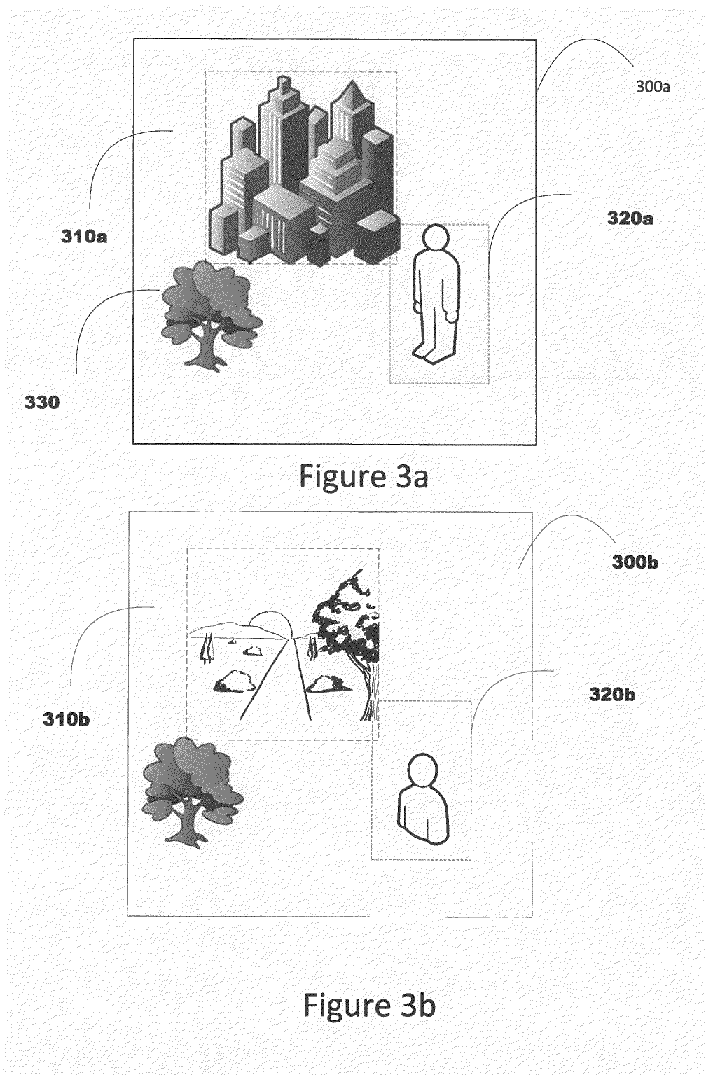

FIG. 3a is a diagram of an exemplary screen view 300a of identified components of an advertisement source 150 in accordance with embodiments of the invention. Screen view 300a represents a photograph that may be used in an exemplary advertisement 152. The screen view 300a includes a generic background 310a and a generic person 320a in the foreground.

FIG. 3b is a diagram of an exemplary screen view 300b of component substitutions of advertisement source 150 in accordance with embodiments of the invention. A user may be more inclined to view or listen to an advertisement 152 if the advertisement 152 contains aspects that appear familiar to the user. In order to present the user with an advertisement 152 that appears more familiar, identified components are substituted with familiar aspects specifically for the user viewing the advertisement 152. The familiar aspects that are substituted are based on user's preferences as determined by methods discussed below. In the exemplary embodiment of presented in FIG. 3, screen view 300b now includes a modified image 310b based on a user preference (i.e. a sunrise) replacing the generic background 310a and a modified image of a person 320b based on a user preference (i.e. an image similar to a friend) in the foreground replacing the generic person 320a. The advertisement 152 is now customized to the user's preference and the user may now be more inclined to notice and follow up on the subject of the advertisement 152.

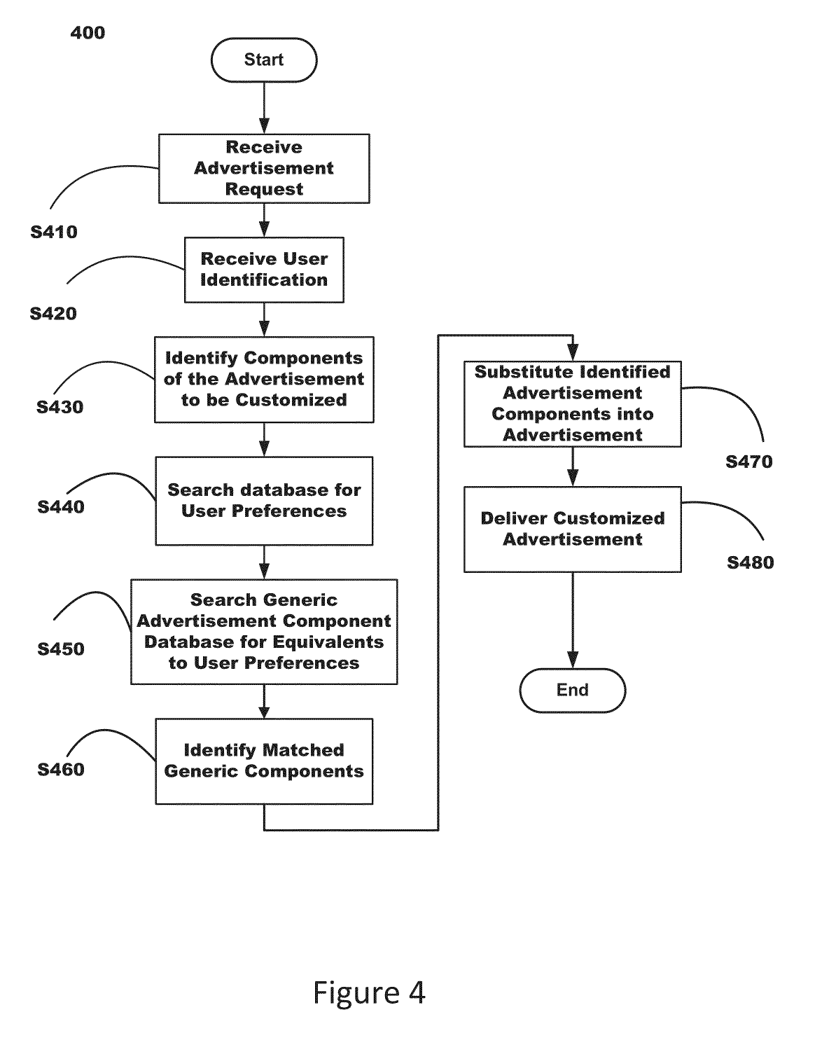

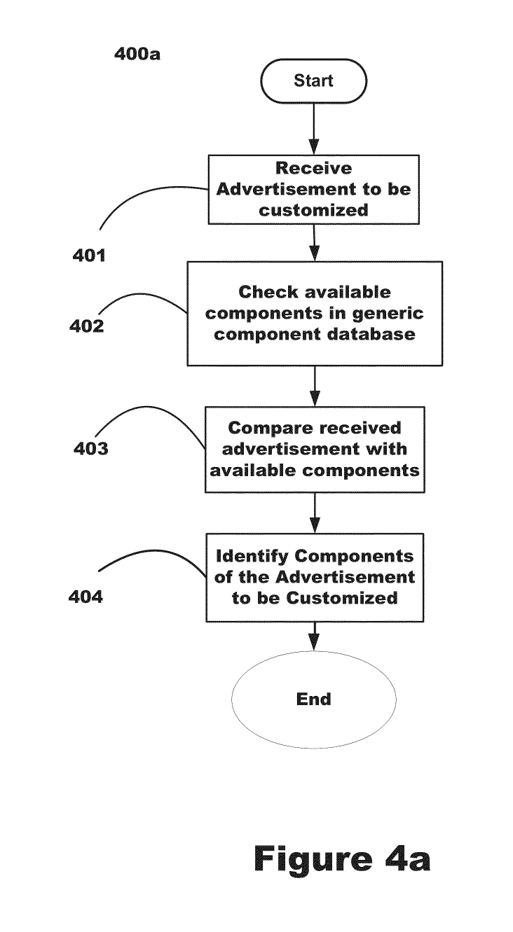

FIG. 4 is a flow diagram of an exemplary method 400 of dynamically customizing an advertisement 152 in accordance with embodiments of the invention.

The method starts at step S410 in which advertisement processing unit 130 receives an API call from website 151 that the website 151 is being accessed and advertisement 152 which will be displayed is available to received data from advertisement source 150. Advertisement 152 may, for example, be embedded in a website that is accessed by a user. The advertisement source 150 for advertisement 152 will, in its original form, contain generic aspects that are not modified for any particular user viewing the advertisement 152. Upon receiving the notification, advertisement processing unit 130 can then modify advertisement source 150 of the advertisement 152 thereby presenting the current user with an advertisement 152 that contains familiar aspects to the current user in accordance with methods of the present invention. Thus, when a user on access device 110 accesses the website 151 with the embedded advertisement 152 through communication network 120, advertisement processing unit 210 receives the notification that advertisement 152 is being prepared for display. One skilled in the art would understand that the advertisement 152 may be accessible in many formats including as an independent site; contained in a launched application; or may be shown as part of any other online source that includes an advertisement.

At step S420, advertisement processing unit 130 determines an identification of the user viewing advertisement 152. The user is identified in order to compile user preferences and to customize the advertisement 152 specifically for the user viewing advertisement 152 as will be discussed in further detail below. The user may be identified when the user accesses communication network 120. The user identification may be compiled based on a user's login profile, for example, such as those available on browsers, social media sites, email applications or the like. Also, the user may be identified when the user connects to an Internet Protocol (IP) telephony network or public switched telephone networks (PSTN).

At step S430, processing unit 210 identifies the components of the advertisement source 150 to be customized.

FIG. 4a is a flow diagram of an exemplary method 400a for identifying components of an advertisement for modification. At step 401, advertisement processing unit 130 receives notification that the advertisement 152 is being displayed in step S410 at which point the advertisement source 150 contains data for the advertisement 152 in its generic form. At step 402, processing unit 210 may start with a general set of available components (i.e. a set of backgrounds, a set of human models, a set of phrases, etc.) which will be used as a basis to identify specific components of the advertisement source 150 for customization. Advertisement processing unit 130 may be previously programmed by an advertiser with parameters for a set of available components of advertisement source 150 that are available for modification while other components are permanent features that cannot be modified. For example, processing unit 210 may check the available components and find components available for modification include backgrounds and human models but a component for a tree. At step S403, processing unit 210 compares the available components in database 140 to the available components for advertisement source 150. At step S404, processing unit 210 identifies the components in advertisement source 150 that will be substituted. Thus, in the exemplary embodiment presented in FIG. 3a, processing unit 210 will identify the background 310a and generic person 320a but will not identify tree 330 as a component to be customized. In other examples, processing unit 210 may identify the sound in an audio or video advertisement, the words in a written message or the like as components of an advertisement that may be substituted. Furthermore, advertisement processing unit 130 may contain parameters by an advertiser within the context of what is being advertised to choose the relevant components for modification. For example, if the context of the advertisement is to sell a shirt, a human model for wearing the shirt as a component to be customized will be an available component for modification by advertisement processing unit 130.

Referring to FIG. 3a, an exemplary screen view of a photographic advertisement 300a is shown. The advertisement processing unit 210 identifies generic background 310a and generic person 320a as components to be customized.

Returning to FIG. 4, at step S440, processing unit 210 searches user database 140 to determine user preferences for the identified user that are relevant to the advertisement components from step S430. Processing unit 210 searches user database 140 which contains data stored by the user and data collected by communication network 120. The data stored on user database 140 includes, for example, recorded conversations, written communications, stored photographs, images of friends and relatives and the like. Processing unit 210 may, for example, determine a preference based on the highest frequency of a component being searched. Referring to the exemplary embodiment described in FIG. 3a, if processing unit 210 is searching for a human image, processing unit may search database 140 for frequent images of a person contained in the user database 140 for the identified user. In this case, processing unit 210 determines a high frequency of photographs of a friend. Thus, processing unit 210 will use the image of a friend to proceed to step S450 of method 400. Another example of processing unit 210 determining a preference is by searching database 140 for recent communications for a voice preference in an audio advertisement. Processing unit 210 queries database 140 in real-time for the user preferences when the advertisement request is received and thus, may determine the most recent conversation with a user contact. A conversation with a user contact may be used as opposed to any recent conversation to distinguish a conversation with someone the user knows and is familiar with rather than with a stranger. Other examples of determining preferences may be through user profiles in social or telephony networks, websites visited recently or often, recent or frequent music or video downloads or streaming, quotes from historical figures or celebrities used in written communications and the like.

The preferences may also be identified through the user profile established in connection with communication network 120. The user profile may contain basic information about the user such as demographic information (i.e. gender, age, etc.), location information, education and the like.

Referring again to FIG. 3a, processing unit 210 will search for user preferences for the identified components of a background 310a and a person 320a. As in the example above, processing unit 210 may search photographs of people and places that the user may have uploaded onto database 140 for example.

At step S450, processing unit 210 searches generic advertisement component database 230 for a generic advertisement components to match with the user preferences of step S440 to produce user centric advertisement components. The search of component database 230 is based on advertiser set parameters for available components within the context of the advertisement. For example, many background components may be available in component database 230 but the advertiser parameters will narrow the set of components available in order to focus the match with the user preference relevant to the advertisement 152.

Referring to FIG. 3a, processing unit 210 may, for example, find a preference for sunrises and an image of a friend that it will use to match with the available generic advertisement components in generic advertisement component database 230.

At step S460, processing unit 210 identifies the preferred user centric advertisement components based on the user's preferences from the available components in generic advertisement component database 230. In the example of FIG. 3a, the processing unit 210 identifies a sunrise 310b and an image of a familiar looking person 320b that has similar features to the user's friend as the user centric advertisement components.

At step S470, processing unit 210 substitutes the identified user centric advertisement components for those of the identified advertisement components to be customized in the advertisement source 150. Referring to FIG. 3b, the processing unit 210 substitutes generic background 310a with sunrise 310b and generic person 310a with the familiar looking person 310b.

At step S480, processing unit 210 delivers the customized advertisement with the user centric advertisement components for access by the user on access device 110.

In one embodiment, in order to a facial recognition program well-known in the art such as Google's® Picasa could be utilized to match the face of a friend from user database 140 with a face of a model in generic advertisement component database 230 for use in the customized advertisement. The facial recognition program can be used to isolate each face and using pattern recognition algorithms such as Principal Component Analysis (PCA) or Linear Discriminant Analysis (LDA) processing unit 210 may scan the available generic advertisement components in generic advertisement component database 230 for the closest match. An advertisement source 150 containing a model would have a face that closely matched the face of a friend of the user.

In another embodiment, processing unit 210 would process an audio analysis of conversations available on user database 140. Audio fingerprinting software such as Audible Magic™ may be employed to analyze audio signals and match the audio imprints available in generic advertisement component database 230 with those available on database 140 for substitution in an audio or video advertisement source 150.

In another embodiment, processing unit 210 may sample phrases used by the user from written communications on user database 140. The user may frequently employ quotes or phrases that the user likes to include in written emails, posts, or SMS messages. For example, processing unit 210 may identify a preference for reading and learning about Abraham Lincoln. Processing unit 210 will identify quotes from Lincoln that may be compared to component phrases in generic advertisement component database 230 within the parameters of the advertisement source 150. Processing unit 210 would then use quotes from Lincoln available in generic advertisement component database 230 substitute them into the advertisement source 150.

In one embodiment, processing unit 210 identifies a background as a component to be customized. Processing unit may sample photographs from user database 140 to determine preferred scenery from the sample that could then be used to match backgrounds from advertisement component database 230 and substituted in the advertisement 150.

The embodiments discussed and figures presented are meant only as examples to illustrate the embodiments of the invention and are not intended as a limitation of the invention. Many variations may be employed in embodiments of the invention.

Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine of the disclosed embodiments is capable of being executed on any computer operating system, and is capable of being performed using any CPU architecture.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A method for dynamically customizing advertisements comprising:
identifying at least one advertisement component of an advertisement for customization;
identifying at least one user preference relevant to the at least one advertisement component; and
modifying the at least one advertisement component based upon the at least one user preference to create a customized advertisement.

2. The method of claim 1, further comprising:
searching a user database for the at least one user preference.

3. The method of claim 2, further comprising:
matching the at least one user preference with at least one generic advertisement component of a plurality of generic advertisement components to produce at least one user centric advertisement component.

4. The method of claim 2, wherein the user database further comprises a user profile, recorded conversations, written communications, or stored photographs.

5. The method of claim 3, wherein the plurality of generic advertisement components further comprises image data, voice data or print data.

6. The method of claim 1, wherein the at least one advertisement component is chosen within a context of the advertisement.

7. The method of claim 1, wherein the advertisement is displayed as an independent online communication, as part of a website, as part of an application, or as part of an online source that includes an advertisement.

8. A system for dynamically customizing advertisements comprising:
a processing unit;
at least one user database; and
at least one generic advertisement component database;
wherein the processing unit is configured to:
identify at least one component of an advertisement for customization;
identify at least one user preference from the user database relevant to the at least one advertisement component; and
modify the at least one advertisement component based upon the at least one user preference to create a customized advertisement.

9. The system of claim 8, wherein the processing unit is further configured to:
search a user database for the at least one user preference.

10. The system of claim 9, wherein the processing unit is further configured to:
match the at least one user preference with at least one generic advertisement component of a plurality of generic advertisement components in the generic advertisement database.

11. The system of claim 9, wherein the user database includes a user profile, recorded conversations, written communications, or stored photographs.

12. The system of claim 10, wherein the plurality of generic advertisement components includes image data, voice data or print data.

13. The method of claim 8, wherein the at least one advertisement component is chosen within a context of the advertisement.

14. The system of claim 8, wherein the advertisement is displayed as an independent online communication, as part of a website, as part of an application, or as part of an online source that includes an advertisement.
